(19) United States
(12) Patent Application Publication
(10) Pub. No.: US 2018/0065414 A1
(43) Pub. Date: Mar. 8, 2018

(54) AIRLESS TIRE

(71) Applicant: RAZOR USA LLC, Cerritos, CA (US)

(72) Inventor: Joey Chih-Wei Huang, Temple City, CA (US)

(21) Appl. No.: 15/692,474

(22) Filed: Aug. 31, 2017

Related U.S. Application Data
(60) Provisional application No. 62/383,185, filed on Sep. 2, 2016.

(51) Int. Cl. B60C 7/10; B60C 7/12

(52) U.S. Cl. CPC B60C 7/102; B60B 3/004; B60C 2007/107; B60C 7/125

(57) ABSTRACT

Various embodiments of an airless tire are disclosed. In some embodiments, the tire can include a hub and a tread. A cushioning unit can be positioned between the hub and the tread. A support can be positioned between, and can provide structural support to, the cushioning unit and the tread.

### CROSS REFERENCE

This application claims the priority benefit under at least 35 U.S.C. § 119 of U.S. Provisional Patent Application No. 62/383,185, filed Sep. 2, 2016, the entirety of which is incorporated by reference herein. This application also incorporates by reference the entirety of U.S. Design application Ser. No. 29/576,480, filed Sep. 2, 2016.

### BACKGROUND

### Field

This disclosure relates generally to wheels, such as airless tires for personal mobility vehicles.

### Description of Certain Related Art

The use of personal mobility vehicles, such as scooters, carts, bicycles, skates, and/or wheeled boards has become a popular recreational activity, as well as a method of personal transportation. Some scooters have pneumatic tires.

### SUMMARY OF CERTAIN FEATURES

With the increased popularity of scooters comes an increased dependence on reliability. Pneumatic tires, such as air-filled tires, generally need to be kept inflated for optimal use. Certain pneumatic tires thus require much attention, maintenance, and upkeep. Certain pneumatic tires for scooters may become deflated due to punctures, ruptures, and/or wear. Pneumatic tires can increase the maintenance required by a user and can reduce the reliability for the scooter overall.

A non-pneumatic tire (also called an “airless tire”) for scooters, carts, bicycles, skates, and/or wheeled boards, among other personal mobility vehicles can solve such issues, or others. Some airless tires can decrease the maintenance required by the user and/or enhance the reliability of the personal mobility vehicle. Some airless tires can provide a low-maintenance and/or reliable wheel for the personal mobility vehicle. This disclosure describes certain embodiments of airless tires.

According to some embodiments, an airless tire can roll across a surface. The airless tire can include a hub, a frame, a tread, and a cushioning unit. The hub can have an opening that can receive an axle. The hub can include a plurality of first securing members. The frame can include a plurality of second securing members. The tread can contact the surface. The tread can be secured to the frame. The cushioning unit can include an inner rim, an outer rim, and a plurality of compression spokes. The inner rim can include a radially inner face that is connected with the hub. The inner face can include a plurality of axially extending flanges that are received in the first securing members of the hub. The outer rim can include a radially outer face that is connected with the frame. The outer face can inlcude a plurality of axially extending flanges that are received in the second securing members of the tread. The plurality of compression spokes can deflect in response to radial compression of the tire. Each of the compression spokes can include a first end coupled with the inner rim and a second end coupled with the outer rim. The second end can be circumferentially offset from the first end. Each of the compression spokes can have an arc shape from a side vantage point of the tire.

In some embodiments, the first securing members on the hub include recesses. In some embodiments, the second securing members on the tread include recesses positioned on radially inwardly-extending rims of the tread. In some embodiments, the tire includes a support ring positioned radially between the tread and the frame. In some embodiments, the support ring comprises metal.

In some embodiments, the compression spokes have an arc radius of less than 15 mm. In some embodiments, the inner rim, the outer rim, and the plurality of compression spokes form a unitary body. In some embodiments, the cushioning unit comprises plastic. In some embodiments, the hub further comprises a plurality of radial spokes.

According to some embodiments, an airless tire rolls across a surface. The airless tire can include a hub, a cushioning unit, a frame, and a tread. The hub can have a plurality of radial spokes and an opening. The opening can receive an axle. The cushioning unit can be positioned radially outward of the hub. The cushioning unit can include an inner rim, an outer rim, a plurality of curved compression spokes, and a plurality of curved apertures. The inner rim can include a radially inner face that is engaged with the hub. The outer rim can include a radially outer face. The plurality of curved compression spokes can deflect in response to radial compression of the tire. Each of the curved compression spokes can extend between the inner rim and the outer rim. The plurality of curved apertures can extend between the inner rim and the outer rim. Each of the curved compression spokes can be circumferentially bounded by at least two of the curved apertures. The frame can be positioned radially outward of the cushioning unit. The frame can be engaged with the radially outer face of the outer rim of the cushioning unit. The tread can be positioned radially outward of the frame. The tread can be secured to the frame and contact the surface.

In some embodiments, the frame can have a substantially I-beam cross-sectional shape. In some embodiments, each of the apertures extends through the entire axial width of the compression unit. In some embodiments, the cushioning unit comprises plastic. In some embodiments, the tire includes a support ring that is positioned radially between the tread and the frame.

Some methods of manufacturing an airless tire include providing a hub, forming a cushioning unit as a unitary piece, receiving the hub in the cushioning unit, engaging securing members of the hub with corresponding securing members of the cushioning unit, providing a frame, receiving the cushioning unit in the frame, engaging securing members of the cushioning unit with corresponding securing members of the frame, and receiving the frame in a tread. The cushioning unit can include an inner rim, an outer rim, and a plurality of curved compression spokes.

In some embodiments, the method includes receiving the frame in the tread includes molding the tread over the frame. In some embodiments, the method includes forming a cushioning unit as a unitary piece and/or includes molding the cushioning unit as a unitary piece. In some embodiments, engaging securing members of the hub with corresponding securing members of the cushioning unit includes receiving flanges of the cushioning unit in corresponding recesses of the hub. In some embodiments, engaging securing members of the cushioning unit with corresponding securing members of the frame includes receiving flanges of the cushioning unit in corresponding recesses of the frame. In some embodiments, the method includes positioning a support ring between the frame and the tread.

Neither the preceding summary, nor the following detailed description, nor the associated drawings purport to limit or define the scope of protection. The scope of protection is defined by the claims.

### BRIEF DESCRIPTION OF THE DRAWINGS

Certain features, aspects, and advantages of the subject matter disclosed herein are described below with reference to the drawings, which are intended to illustrate, and not to limit, the scope of the disclosure. Various features of different disclosed embodiments can be combined to form additional embodiments, which are part of this disclosure. No structures, features, steps, or processes are essential or critical; any can be omitted.

FIG. 1 schematically illustrates an embodiment of an airless tire on a personal mobility vehicle.

FIG. 2 illustrates an embodiment of airless tire on an example of a personal mobility vehicle, such as a scooter.

FIG. 3 illustrates a perspective view of an embodiment of an airless tire.

FIG. 4 illustrates an exploded perspective view of the airless tire of FIG. 3, showing certain portions of the airless tire.

FIG. 5 illustrates a right side view of the airless tire of FIG. 3.

FIG. 6 illustrates a left side view of the airless tire of FIG. 3.

FIG. 7 illustrates a front view of the airless tire of FIG. 3.

FIG. 8 illustrates a rear view of the airless tire of FIG. 3.

FIG. 9 illustrates a top view of the airless tire of FIG. 3.

FIG. 10 illustrates a bottom view of the airless tire of FIG. 3.

FIG. 11 illustrates a cross-sectional view of the airless tire of FIG. 3 along the line 11-11 as shown in FIG. 5.

### DETAILED DESCRIPTION OF CERTAIN EMBODIMENTS

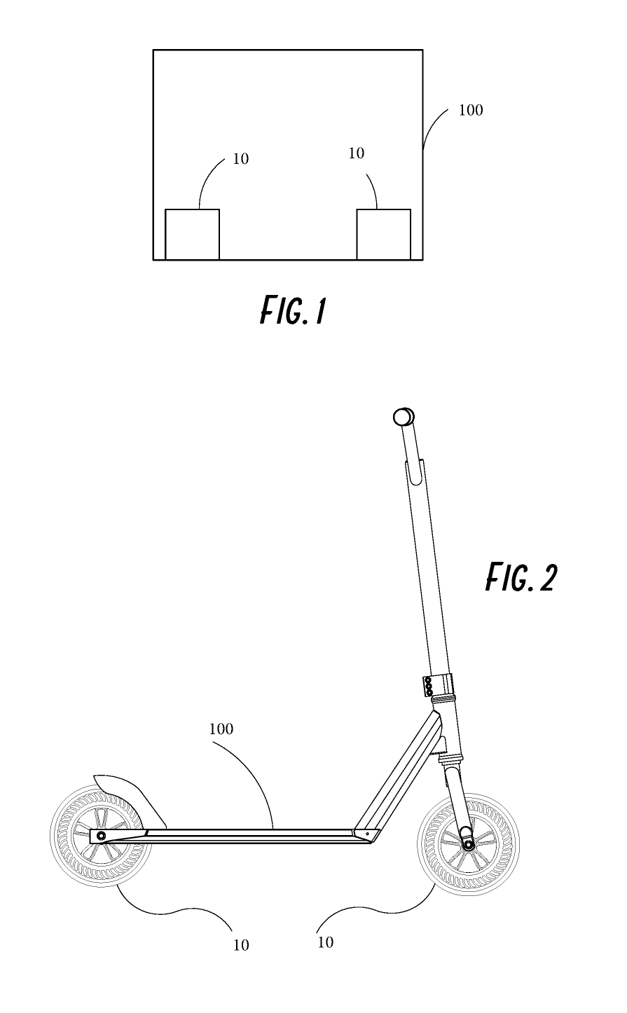

Various embodiments of airless tires are disclosed herein. The disclosed embodiments are generally described in the context of a scooter, due to particular utility in that context. However, the airless tires disclosed herein can also be applied to other types of personal mobility vehicles, such as carts, bicycles, skates, wheeled boards, or otherwise. The airless tire can be used in conjunction with motorized and/or non-motorized scooters or other personal mobility vehicles. As shown in FIGS. 1 and 2, the airless tire can be used on a scooter, cart, bicycle, skate, wheeled board, or other personal mobility vehicle. The personal mobility vehicle can be driven by a motor, such as an electric motor (e.g., a standard electric motor and/or a hub motor). In some embodiments, the airless tire can be used on a scooter, cart, bicycle, skate, wheeled board, or other personal mobility vehicle that is driven by human power.

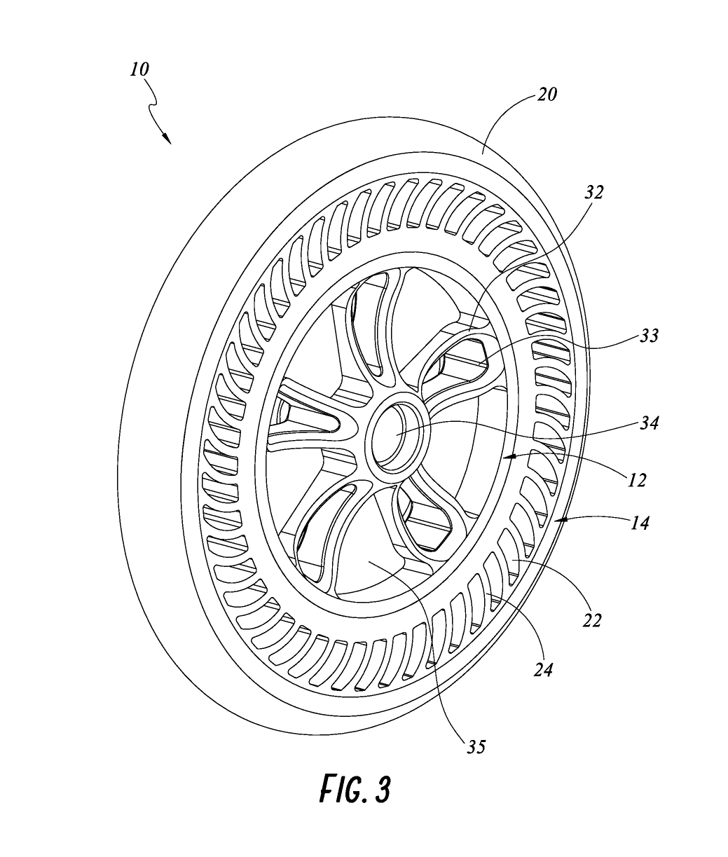

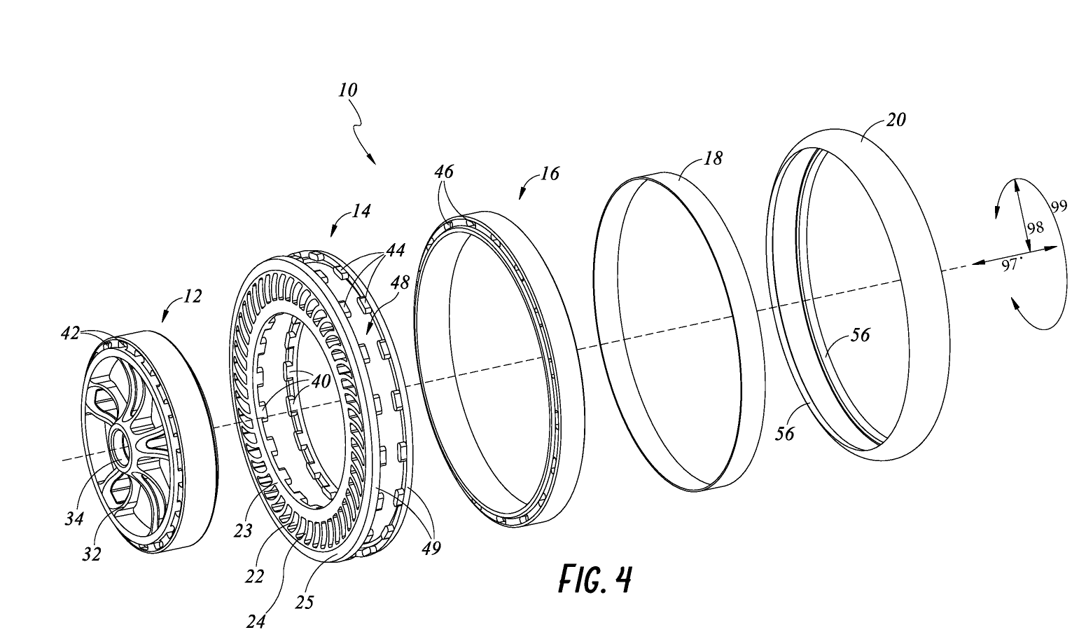

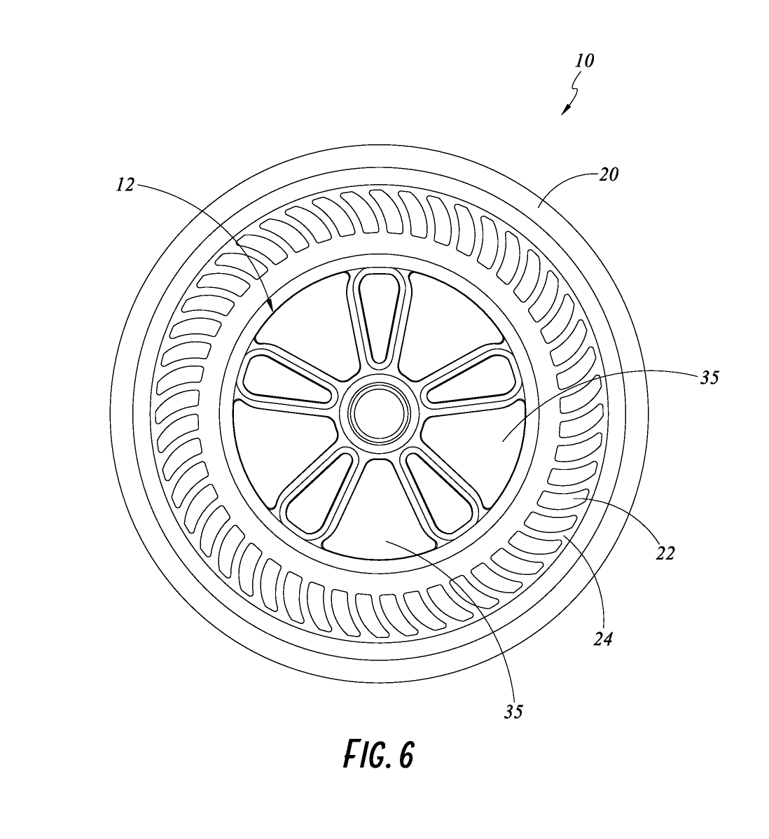

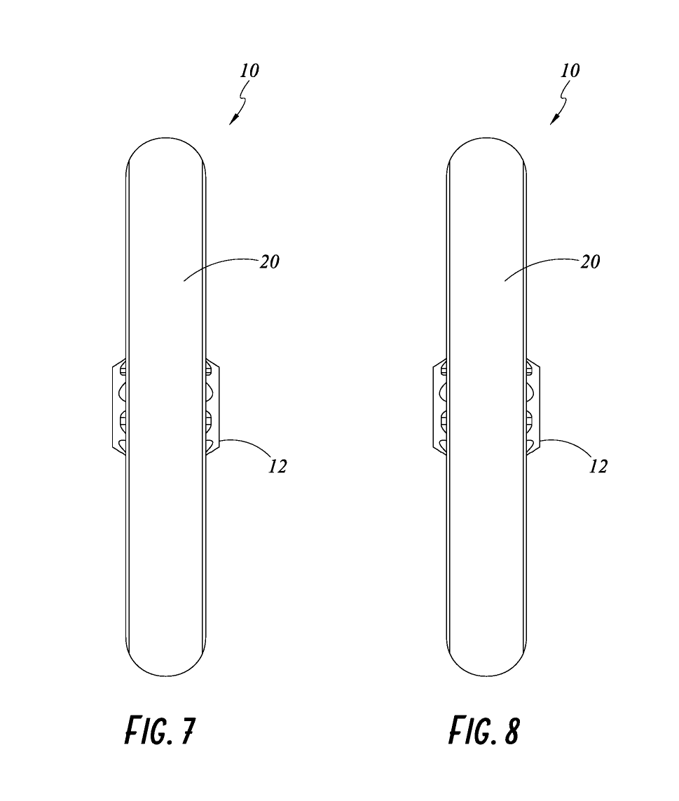

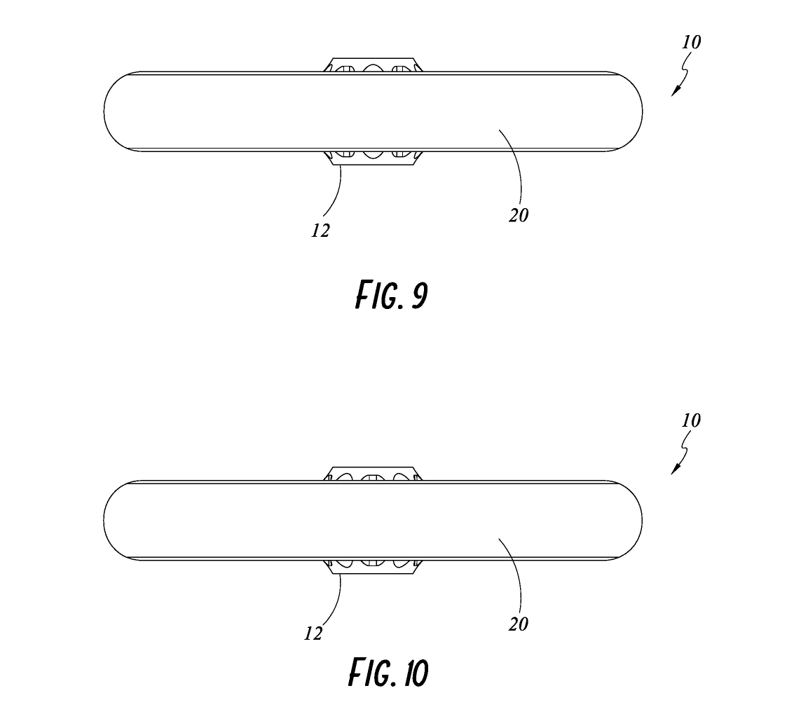

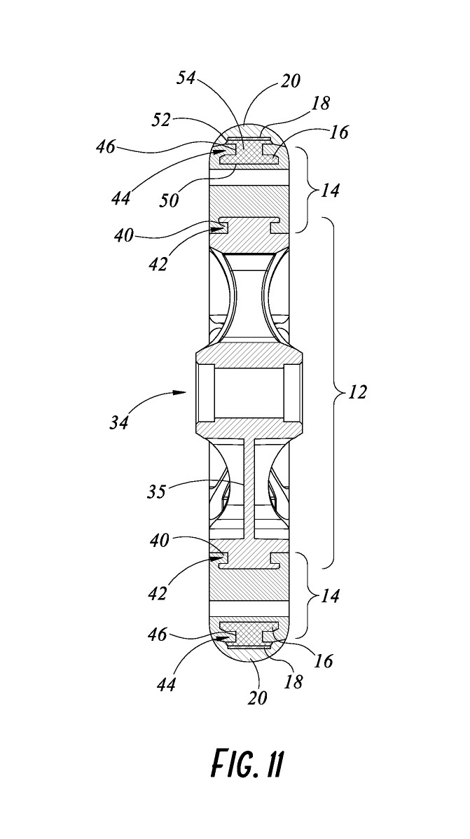

FIGS. 3-11 illustrate various views of an airless tire 10. FIG. 4 shows an exploded view of the airless tire 10 showing certain portions of the airless tire 10. In some embodiments, the tire 10 can include a hub 12, a cushioning unit 14, a frame 16, a support 18, and/or a tread 20. These and other features will be described in more detail below.

### Hub

As shown in FIG. 3, as well as in at least FIGS. 4-6, and 11, the hub 12 can include a hub opening 34. The hub opening 34 can be configured to mount on an axle of a wheel assembly of a scooter, cart, bicycle, skate, wheeled board, or other personal mobility vehicle 100. After being mounted, the airless tire 10 can rotate around the axle in a forward and/or rearward direction. In some embodiments, the airless 10 can include an axis of rotation about which the airless tire 10 rotates. The axis of rotation can extend in an axial direction 97. In some embodiments, portions of the airless tire 10 are positioned and/or extend in a radial direction 98. In some embodiments, portions of the airless tire 10 are positioned and/or extend in a circumferential direction 99.

In some embodiments, the hub 12 includes a plurality of radially extending spokes 32. Some embodiments include 1, 2, 3, 4, 5, 6, 7, or more spokes 32. The spokes 32 can include one, two, or more side walls. Each of the spokes 32 can have a same and/or a different shape. In some configurations, the spokes 32 can be spaced apart by the same and/or varying radial distances. In some embodiments, the spokes 32 can be uniformly distributed about the hub opening 34. As shown, the spokes 32 can include axial recesses and/or apertures 33. The apertures 33 can form an opening that extends through all or a portion of a thickness of the tire 10. In some embodiments, the apertures 33 can have a generally similar or identical shape to an outer perimeter of the spokes 32. The apertures 33 can reduce the weight of the tire 10 and/or the vehicle 100. In certain variants, the spokes 32 are generally solid (e.g., do not include axial holes).

In some embodiments, the hub 12 includes a web 35. The web 35 can be positioned circumferentially between two or more spokes 32. As shown, the web 35 can include a generally solid wall. Certain configurations of the wall can improve the strength of the hub 12 and/or the overall tire 10.

In certain implementations, instead of and/or in addition to the web 35, the hub 12 includes openings circumferentially between the spokes 32. The openings can be formed between a pair of adjacent spokes 32. In some embodiments, the openings can extend through all or a portion of a thickness of the tire 10. In some embodiments, the openings can each be the same and/or different sizes and/or shapes. In some embodiments, the openings can enhance the aerodynamics of the tire 10 and/or can allow the vehicle 100 to move more easily, speed up more quickly, and/or slow down more quickly, among other benefits. This can reduce the weight of the tire 10, ease manufacturing, reduce costs, etc. In various embodiments, the hub 12 is configured to not substantially deflect as the tire 10 rolls over a riding surface (e.g., a flat and/or bumpy surface upon which the tire 10 rolls over). In some embodiments, the hub 12 is generally rigid as the tire 10 rolls over the riding surface.

In some embodiments, the hub 12 can include one or more recesses 42. The recesses 42 can radially surround the hub 12 along an outer end of the hub 12. The recesses 42 are described in more detail below.

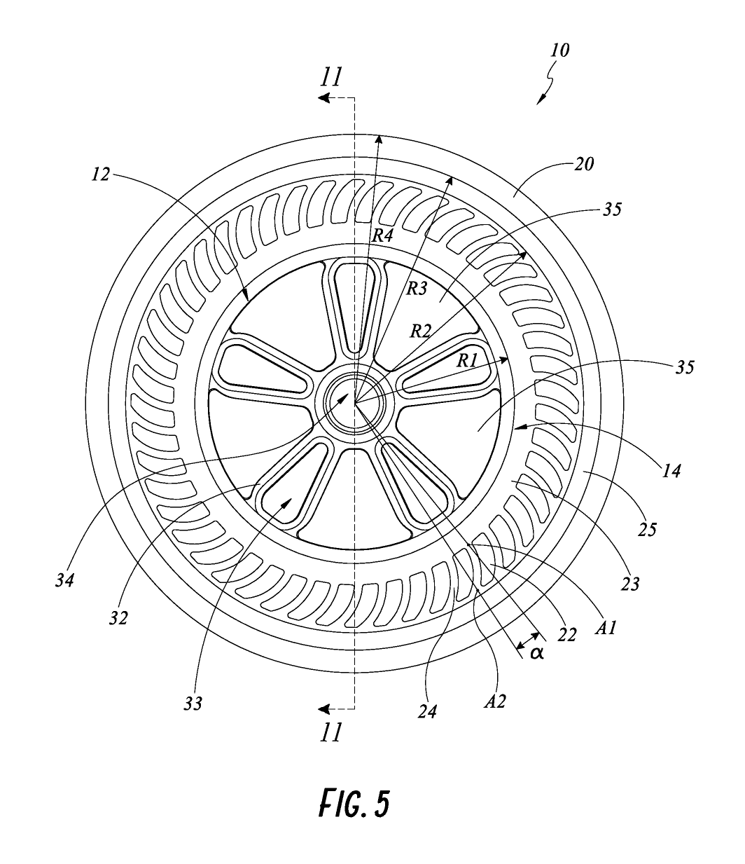

As illustrated in FIG. 5, the hub 12 can have a radius R1, the cushioning unit 14 can have a radius R2, the frame 16 can have a radius R3, and/or the tread 20 can have a radius R4. In some embodiments, the radius R2 is greater than the radius R1. In some embodiments, the radius R3 is greater than the radius R2. In some embodiments, the radius R4 is greater than the radius R3. For example, the ratio of R2 to R1 can be at least about: 1.25, 1.5, 1.75, 2.0, 2.25, ratios between the aforementioned ratios, or other ratios. In certain variants, the ratio of radius R3 to radius R1, radius R4 to radius R1, radius R4 to radius R2, radius R4 to radius R3, and/or radius R3 to radius R2, is at least about: 1.5, 1.75, 2.0, 2.25, 2.5, ratios between the aforementioned ratios, or other ratios.

### Cushioning Unit

As mentioned above, the tire 10 can include the cushioning unit 14. The cushioning unit 14 can be positioned between the hub 12 and the tread 20. In some embodiments, at least a portion of the cushioning unit 14 can be positioned between the hub 12 and the frame 16 and/or the support 18. The cushioning unit 14 can transfer rotational force from the hub 12 to the tread 20. The cushioning unit 14 can be generally annular in shape, among other shapes.

In some embodiments, the cushioning unit 14 can include a plurality of apertures 22, an inner rim 23, a plurality of compression spokes 24, and/or an outer rim 25. As discussed in more detail below, the inner rim 23 can couple with the hub 12 and/or the outer rim 25 can couple with the frame 16 and/or the tread 20. In some embodiments, the plurality of compression spokes 24 of the cushioning unit 14 can be positioned radially outward of the spokes 32 of the hub 12. The cushioning unit 14 can include at least 1, 2, 10, 20, 30, 40, 48, or 50 or more compression spokes 24.

As illustrated, the compression spokes 24 can extend between the inner and outer rims 23, 25. The compression spokes 24 can be configured to deflect (e.g., compress, buckle, etc.) in the radial direction, such as in response to radial compression of the tread 20. Radial compression of the tread 20 may occur when the tire 10 passes over a rock or other obstacle. Deflection of the compression spokes 24 can allow the tire 10 to provide suspension and/or dampening. For example, in certain embodiments, deflection of the compression spokes 24 can reduce or eliminate bumps, and/or vibration from being transferred from the tread 20 to the hub 12. This can provide a smoother ride, can reduce noise, and/or can facilitate maintaining control of the personal mobility vehicle 100 (e.g., scooter), among other benefits. In certain implementations, a circumferential distance between adjacent compression spokes 24 is decreased and/or eliminated (e.g., at least some adjacent compression spokes 24 abut each other), such as when the compression spokes 24 deflect.

In some embodiments, the compression spokes 24 can have an axial width that is substantially the same as, and/or greater than, the axial width of the hub 12 and/or the tread 20. In certain variants, the compression spokes 24 are narrower than the hub 12 and/or the tread 20. The compression spokes 24 can have substantially the same axial width along substantially their entire radial length. As shown, the compression spokes 24 can be curved, bent, and/or arced. In some embodiments, the compression spokes 24 can have a radius of curvature of less than or equal to about: 15 mm, 12 mm, 10 mm, 8 mm, values between the aforementioned values, or other values.

In some embodiments, the compression spokes 24 can be integrally formed with, and/or are unitary with, the inner rim 23 and/or the outer rim 25. The compression spokes 24 can be made of the same or different material as the inner rim 23 and/or the outer rim 25. In some embodiments, the compression spokes 24 are part of the same overall component as, and/or are not a separate component from, the inner rim 23 and/or the outer rim 25. In certain variants, the compression spokes 24 are a separate component from the inner rim 23 and/or the outer rim 25. In some embodiments, the compression spokes 24 are connected to the inner rim 23 and/or the outer rim 25 with a fastener, such as a rivet, bolt, or other mechanical fastener. In certain implementations, the compression spokes 24 can be formed during the same manufacturing process as the inner rim 23 and/or the outer rim 25. For example, the compression spokes 24 and the inner rim 23 and/or outer rim 25 can be formed during a common molding, casting, or other process.

In some embodiments, the compression spokes 24 can extend from (e.g., between) the inner rim 23 to the outer rim 25. As illustrated, the compression spokes 24 can extend radially outward from the inner rim 23 toward the outer rim 25. As shown, the compression spokes 24 can curve circumferentially. In some embodiments, the compression spokes 24 can be generally straight. In some embodiments, at least some or all of the compression spokes 24 curve in a same circumferential direction and/or a different circumferential direction. For example, as shown in FIG. 5, all of the compression spokes 24 extend radially from the inner rim 23 to the outer rim 25 and/or curve circumferentially in a clockwise direction. As illustrated in at least FIG. 5, the arrangement of the compression spokes 24 can form a generally spiral shape and/or effect. In some embodiments, when the tire 10 rotates about the axle and/or the rolling axis, a visual effect is displayed, such as a spiral shape and/or effect.

In some embodiments, the compression spokes 24 extend from a region Al on the inner rim 23 to a region A2 on the outer rim 25. As shown, the regions A1, A2 can be circumferentially offset. In some embodiments, respective circumferential midpoints of the regions A1, A2 are offset by an angle α. In certain implementations, the angle α can be less than or equal to about: 20°, 15°, 10°, 5°, 4°, 3°, 2°, 1°, angles between the aforementioned angles, or other angles. In certain implementations, the compression spokes 24 form a pattern (e.g., the illustrated generally spiral pattern) in only one circumferential direction, such as only clockwise or only counterclockwise.

As mentioned above, the cushioning unit 14 can include apertures 22. The apertures 22 can be interspaced between the compression spokes 24. The apertures 22 can be positioned between adjacent compression spokes 24 and/or positioned adjacent to at least one of the compression spokes 24. In some embodiments, each of the compression spokes 24 can be circumferentially bounded by two of the apertures 22. In some embodiments, the apertures 22 extend from the inner rim 23 to the outer rim 25. In some embodiments, the aperture 22 can have generally the same shape and/or pattern as the spokes 24. In certain implementations, the apertures 22 extend axially through the entire cushioning unit 14. In some embodiments, the apertures 22 extend axially through at least a portion of the cushioning unit 14. In some variants, the apertures 22 provide an axial passageway from one axial side of the tire 10 to the other axial side of the tire 10.

In certain embodiments, substantially the entire and/or the entire passageway is unobstructed. Some embodiments do not have other features that pass through the passageway in a radial and/or circumferential direction. In some embodiments, the passages are configured to enable a line of sight from one axial side of the tire 10 to the other axial side of the tire 10. In certain variants, the line of sight is unobstructed along substantially the entire or the entire passageway.

As illustrated in FIG. 5, the apertures 22 can be similarly shaped and/or sized as the compression spokes 24. For example, as shown, both can be arced, can be curved in the same and/or different direction, and/or can have about the same arc radius. In some variants, the apertures 22 are circumferentially wider than the compression spokes 24. In certain configurations, the ratio of the circumferential width (e.g., taken at the respective radial midpoints) of the apertures 22 to the compression spokes 24 can be at least about: 1.5, 1.75, 2.0, 2.25, 2.5, ratios between the aforementioned ratios, or other ratios.

The compression spokes 24 can allow the cushioning unit 14 to compress in a radial direction. This can allow the tire 10 to accommodate irregularities in the riding surface upon which the personal mobility vehicle 100 travels. Certain configurations can provide some bump absorption (e.g., dampening) and/or a suspension, such as in a manner similar to a pneumatic tire. In some embodiments, the compression spokes 24 can elastically compress in the radial direction by at least about: 5 mm, 10 mm, 15 mm, 20 mm, 30 mm, or more. In certain implementations, the cushioning unit 14 provides a resilient force that limits the radial compression of the tread 20. Such configurations can provide a more stable and/or a smoother riding experience.

The cushioning unit 14 can be constructed of a material that is different from the hub 12 and/or the tread 20. In some configurations, the cushioning unit 14 is constructed from a plastic, such as polyurethane, among other materials. In some implementations, the hub 12 is constructed from a relatively rigid plastic, such as ABS, and/or the tread 20 is constructed from a rubber or a rubber-like material. Other materials for the cushioning unit 14, hub 12, and the tread 20 are contemplated.

As mentioned above, at least a portion of the cushioning unit 14, such as the inner rim 23 can couple with the hub 12. As shown in at least FIGS. 4 and 11, the hub 12 and cushioning unit 14 can include features that matingly engage. Some configurations can secure the inner rim 23 of the cushioning unit 14 to the hub 12. In some embodiments, the inner rim 23 of the cushioning unit 14 includes first securing members, such as flanges 40. The flanges 40 can be generally T-shaped, I-shaped, and/or straight, among other configurations. In some embodiments the cushioning unit 14 can include one, two, three, four, or five or more flanges 40. In some embodiments, the hub 12 can include second securing members, such as recesses 42. In some embodiments, the recesses 42 can have complementary shapes to the flanges 40. Such configurations can help to securely engage the recesses 42 with corresponding flanges 40. In some embodiments, the hub 12 can include one, two, three, four, or five or more recesses 42. In some embodiments, the flanges 40 and/or the recesses 42 can be spaced apart circumferentially about the hub 12 and/or the cushioning unit 14. The recesses 42 can receive the flanges 40. Some variants can securely couple the inner rim 23 of the cushioning unit 14 and the hub 12. In some embodiments, the flanges 40 can axially extend from the edges of the inner rim 23. In some embodiments, the flanges 40 can axially extend from the first and/or second edges of the inner rim 23, such as in pairs as shown.

### Frame

As illustrated in at least FIG. 4, the frame 16 can include a generally annular shape. The frame 16 can be generally rigid and/or stiffer than the cushioning unit 14 and/or the tread 20. The frame 16 can aid in providing structural support to the tire 10. In some embodiments, the frame 16 connects the tread 20 with the cushioning unit 14. In some embodiments, the tread 20 is molded onto the frame 16 (e.g., is overmolded such that the tread 20 wraps around a portion of the axial sides of the frame 16) and/or is otherwise securely formed with the frame 16. The frame 16 can provide a structure to connect with the cushioning unit 14.

In certain embodiments, the frame 16 can couple with at least a portion of the cushioning unit 14, such as the outer rim 25. As shown in at least FIGS. 4 and 11, the frame 16 and the cushioning unit 14 can include features that matingly engage. Some configurations can secure the outer rim 25 of the cushioning unit 14 to the frame 16. In some embodiments, the outer rim 25 of the cushioning unit 14 can include first securing members, such as flanges 44. The flanges 44 can be generally T-shaped, I-shaped, and/or straight, among other configurations. In some embodiments, the cushioning unit 14 can include one, two, three, four, or five or more flanges 44. In some embodiments, the frame 16 can include second securing members, such as recesses 46. In some embodiments, the recesses 46 can have complementary shapes to the flanges 44. Such configurations can help to securely engage the recesses 46 with corresponding flanges 44. In some embodiments, the frame 16 can include one, two, three, four, or five or more recesses 46. In some embodiments, the flanges 44 and/or the recesses 46 can be spaced apart circumferentially about the frame 16 and/or the cushioning unit 14. The recesses 46 can receive the flanges 44. Some variants can securely couple the frame 16 with the outer rim 25 of the cushioning unit 14. In some embodiments, the flanges 44 can axially extend from the edges of the outer rim 25. In some embodiments, the flanges 44 can axially extend from the first and second edges of the outer rim 25, such as in pairs as shown. As shown, the outer rim 25 can include a channel 48 that is radially recessed. The channel 48 can axially be bounded by the first and/or second rims 49.

In some embodiments, the frame 16 can include a shape that aids in providing stability and/or engagement between the frame 16 and the cushioning unit 14. In some embodiments, the frame 16 can include the recesses 46. The recesses 46 can aid in engaging the frame 16 and the cushioning unit 14. As shown in at least FIG. 11, the frame 16 can have a generally I-beam cross-sectional shape, among other shapes. In some embodiments, the frame 16 can have an inner flange 50 and/or an outer flange 52. The inner and/or outer flanges 50, 52 can be connected with a web 54. The web 54 can be axially thinner than the flanges 50, 52. In some embodiments, the inner flange 50 can have about a same axial thickness as, or greater than, an axial thickness of the outer flange 52. In certain variants, the frame 16 can have other cross-sectional shapes, such as a generally T-beam shape, generally rectangular, or otherwise.

### Support

In some configurations, the tire 10 can include the support 18. The support 18 can provide strength and/or stability to the tread 20 and/or the tire 10. As illustrated in at least FIG. 4, the support 18 can be thicker in the axial dimension than in the radial dimension. The support 18 can have a generally rectangular cross-sectional shape, among other shapes. As shown at least in FIG. 11, the support 18 can engage with (e.g., abut against) at least a portion of the frame 16, such as the outer flange 52. In some embodiments, the support 18 can have an axial thickness that is about the same as, or less than, the axial thickness of the outer flange 52. In various embodiments, the support 18 can include a band of metal, such as steel, stainless steel, aluminum, or otherwise. In certain implementations, the support 18 can include a single component, not an assembly of multiple components. In some embodiments, the support 18 can be integrally formed as a single body.

### Tread

In some embodiments, the tread 20 can directly engage with the riding surface (e.g., dirt, gravel, pavement, etc.). In some embodiments, the tread 20 is made of rubber or a rubber-like material. Other materials are contemplated as well. In some embodiments, an outer side of the tread 20 is generally smooth. In some embodiments, the tread 20, such as the outer side of the tread 20, has grooves and/or a tread pattern.

As shown in at least FIG. 4, the tread 20 can have an inner surface. The inner surface can include at least one rim 56 (e.g., two or more rims 56). The rims 56 can engage with other components of the tire 10. The rims 56 can aid in securing the tread 20. In certain variants, the tire 10 includes an opening and/or recess formed axially between adjacent rims 56. In certain variants, the opening between the rims 56 can receive at least a portion of the cushioning unit 14 and/or the frame 16. In some embodiments, the tread is formed (e.g., integrally formed or molded) with one or more of the other components of the tire 10. For example, the tread 20 can be overmolded onto the cushioning unit 14 and/or the frame 16.

### Certain Terminology

Although the discussion above describes the tire 10 as an “airless tire,” this does not mean the tire 10 cannot include any air or other gas. For example, air or other gas may be present in the apertures 22 or other portions of the tire 10. The term “airless tire” is a term of art that distinguishes the tire 10 from a pneumatic tire (e.g., a tire that includes a rubber outer cover with an impermeable lining that contains compressed air or other gas).

Certain terminology may be used in the description for the purpose of reference only, and thus is not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Terms of orientation used herein, such as “top,” “bottom,” “horizontal,” “vertical,” “longitudinal,” “lateral,” and “end” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular” or “cylindrical” or “semi-circular” or “semi-cylindrical” or any related or similar terms, are not required to conform strictly to the mathematical definitions of circles or cylinders or other structures, but can encompass structures that are reasonably close approximations.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes, or tends toward, a particular value, amount, or characteristic. For example, as the context may dictate, the term “generally parallel” can mean something that departs from exactly parallel by less than or equal to 15°. Furthermore, as the context may dictate, the term “generally perpendicular” can mean something that departs from exactly, perpendicular by less than or equal to 15°. Furthermore, as the context may dictate, the term “generally aligned” can mean something that departs from exactly, aligned by less than or equal to 15°.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a device configured to carry out recitations A, B, and C” can include a first device configured to carry out recitation A working in conjunction with a second device configured to carry out recitations B and C.

The terms “comprising,” “including,” “having,” and the like are synonymous and are used inclusively, in an open-ended fashion, and do not exclude additional elements, features, acts, operations, and so forth Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

### Summary

The airless tire has been disclosed in the context of certain embodiments and examples above. However, this disclosure extends beyond the specifically disclosed embodiments to other alternative embodiments and/or uses and obvious modifications and equivalents thereof. In particular, while the airless tire has been described in the context of illustrative embodiments, certain advantages, features, and aspects of the airless tire may be realized in a variety of other applications. Various features and aspects of the disclosed embodiments can be combined with or substituted for one another in order to form varying modes of the airless tire. The scope of this disclosure should not be limited by the particular disclosed embodiments described herein.

Additionally, various aspects and features of the embodiments described can be practiced separately, combined together, or substituted for one another. A variety of combination and subcombinations of the disclosed features and aspects can be made and still fall within the scope of this disclosure. Certain features that are described in this disclosure in the context of separate implementations can also be implemented in combination in a single implementation. Conversely, various features that are described in the context of a single implementation can also be implemented in multiple implementations separately or in any suitable subcombination. Although features may be described above as acting in certain combinations, one or more features from a claimed combination can, in some cases, be excised from the combination, and the combination may be claimed as any subcombination or variation of any subcombination.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Some embodiments have been described in connection with the accompanying drawings. The figures are drawn to scale, but such scale should not be limiting, since dimensions and proportions other than what are shown are contemplated and are within the scope of this disclosure. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

In summary, various embodiments and examples of airless tires for personal mobility devices, such as scooters, have been disclosed. Although the airless tires have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Thus, the scope of this disclosure should not be limited by the particular embodiments described above, but should be determined only by a fair reading of the claims that follow.

The following is claimed:

1. An airless tire that is configured to roll across a surface, the airless tire comprising:
a hub having an opening configured to receive an axle, the hub comprising a plurality of first securing members;
a frame comprising a plurality of second securing members;
a tread configured to contact the surface, the tread secured to the frame;
a cushioning unit comprising:
an inner rim comprising a radially inner face that is connected with the hub, the inner face comprising a plurality of axially extending flanges that are received in the first securing members of the hub;
an outer rim comprising a radially outer face that is connected with the frame, the outer face comprising a plurality of axially extending flanges that are received in the second securing members of the tread; and
a plurality of compression spokes configured to deflect in response to radial compression of the tire, each of the compression spokes comprising a first end coupled with the inner rim and a second end coupled with the outer rim, the second end being circumferentially offset from the first end.

2. The airless tire of claim 1, wherein each of the compression spokes have an arc shape from a side vantage point of the tire.

3. The airless tire of claim 1, wherein the first securing members on the hub comprise recesses.

4. The airless tire of claim 1, wherein the second securing members on the tread comprise recesses positioned on radially inwardly-extending rims of the tread.

5. The airless tire of claim 1, further comprising a support ring positioned radially between the tread and the frame, wherein the support ring comprises metal.

6. The airless tire of claim 1, wherein the compression spokes have an arc radius of less than 15 mm.

7. The airless tire of claim 1, wherein the inner rim, the outer rim, and the plurality of compression spokes form a unitary body.

8. The airless tire of claim 1, wherein the cushioning unit comprises plastic.

9. The airless tire of claim 1, wherein the hub further comprises a plurality of radial spokes.

10. An airless tire that is configured to roll across a surface, the airless tire comprising:
a hub having a plurality of radial spokes and an opening, the opening configured to receive an axle;
a cushioning unit positioned radially outward of the hub, the cushioning unit comprising:
an inner rim comprising a radially inner face that is engaged with the hub;
an outer rim comprising a radially outer face;
a plurality of curved compression spokes configured to deflect in response to radial compression of the tire, each of the curved compression spokes extending between the inner rim and the outer rim; and
a plurality of curved apertures, each of the curved apertures extending between the inner rim and the outer rim;
wherein each of the curved compression spokes is circumferentially bounded by at least two of the curved apertures;
a frame positioned radially outward of the cushioning unit, the frame engaged with the radially outer face of the outer rim of the cushioning unit; and
a tread positioned radially outward of the frame, the tread secured to the frame and configured to contact the surface.

11. The airless tire of claim 10, wherein the frame has a substantially I-beam cross-sectional shape.

12. The airless tire of claim 10, wherein each of the apertures extends through the entire axial width of the compression unit.

13. The airless tire of claim 10, wherein the cushioning unit comprises plastic.

14. The airless tire of claim 10, further comprising a support ring that is positioned radially between the tread and the frame.

15. A method of manufacturing an airless tire, the method comprising:
obtaining a hub;
forming a cushioning unit as a unitary piece, the cushioning unit comprising:
an inner rim,
an outer rim; and
a curved compression spokes;
receiving the hub in the cushioning unit;
engaging securing members of the hub with corresponding securing members of the cushioning unit;
obtaining a frame;
receiving the cushioning unit in the frame;
engaging securing members of the cushioning unit with corresponding securing members of the frame; and
receiving the frame in a tread.

16. The method of claim 15, wherein receiving the frame in the tread comprises molding the tread over the frame.

17. The method of claim 15, wherein forming a cushioning unit as a unitary piece comprises molding the cushioning unit as a unitary piece.

18. The method of claim 15, wherein engaging securing members of the hub with corresponding securing members of the cushioning unit comprises receiving flanges of the cushioning unit in corresponding recesses of the hub.

19. The method of claim 15, wherein engaging securing members of the cushioning unit with corresponding securing members of the frame comprises receiving flanges of the cushioning unit in corresponding recesses of the frame.

20. The method of claim 15, further comprising positioning a support ring between the frame and the tread.
